(19) United States
(12) Patent Application Publication
(10) Pub. No.: US 2010/0163811 A1
(43) Pub. Date: Jul. 1, 2010

(54) Organic Layer Photosensitive Resin Composition and Organic Layer Fabricated Using Same

(75) Inventors: Hee-Young OH, Uiwang-si (KR); Jong-Seung PARK, Uiwang-si (KR); In-Jae LEE, Uiwang-si (KR); Guk-Pyo JO, Uiwang-si (KR); Dong-Seon UH, Uiwang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: Cheil Industries Inc., Gumi-si (KR)

(21) Appl. No.: 12/504,409

(22) Filed: Jul. 16, 2009

(30) Foreign Application Priority Data
Dec. 31, 2008 (KR) 10-2008-0138782

(51) Int. Cl. G02B 5/23; C08K 5/3432

(52) U.S. Cl. 252/586; 524/99

(57) ABSTRACT

Disclosed is an organic layer photosensitive resin composition and an organic layer fabricated using the same. The organic layer photosensitive resin composition includes (A) an organic binder resin, (B) a reactive unsaturated compound, (C) a polymerization initiator, (D) a black pigment including a lactam-based black pigment, and (E) a solvent.

### CROSS-REFERENCE TO RELATED APPLICATION

This application claims priority to and the benefit of Korean Patent Application No. 10-2008-0138782 filed in the Korean Intellectual Property Office on Dec. 31, 2008, the entire disclosure of which is incorporated herein by reference.

### FIELD OF THE INVENTION

The present invention relates to an organic layer photosensitive resin composition and an organic layer fabricated using the same.

### BACKGROUND OF THE INVENTION

With many advantageous properties such as light weight, thinness, low price, low power consumption, and fine joining property with an integrated circuit, the various uses for liquid crystal display devices have increased to include such fields as laptop computers, personal digital assistants (PDAs), mobile phones, and color television (TV) sets, among others. A liquid crystal display device is formed of a lower substrate including a light shield film (e.g., black matrix), a color filter, and an ITO pixel electrode; an active circuit portion including a liquid crystal film, a thin film transistor, and a condensing capacitor film; and an upper substrate including an ITO pixel electrode. The lower substrate may be referred to as a color filter array, and the upper substrate may be referred to a TFT array. The color filter can be fabricated by forming red pixels, green pixels, and blue pixels and the light shield film on a glass substrate using a photosensitive resin composition with dispersed pigment particulates.

The light shield film blocks light that is not transmitted through a transparent pixel electrode of the substrate in order to prevent decreasing contrast due to light transmitted through the thin film transistor. Specific wavelengths of white light are transmitted through red, green, and blue pigment layers to thereby express colors.

In general, a color filter substrate is fabricated using dyeing, printing, pigment dispersion, electrophoretic deposition (EPD), inkjet printing, and the like.

In the dyeing method, a color filter substrate is fabricated by forming a light shield film on a glass substrate; coating the substrate having the light shield film, with a photosensitive solution, which is prepared by adding dichromate to a natural photosensitive resin such as gelatin, and a synthesized photosensitive resin such as an amine modified polyvinyl alcohol and an amine modified acryl resin; and exposing the resultant structure to light through a photomask and developing the resultant structure with a photomask pattern, or dyeing it using a masking layer and an acidic dye pigment. However, since multiple colors need to be formed on the same substrate, anti-dye processing should be performed whenever a color is changed. This lengthens and complicates the process. Also, generally used dyes and resins have fine dispersion and clearness but they have poor heat resistance, which is one of the most important properties of a color filter, as well as low light resistance and water resistance.

In the printing method, a colored thin film is fabricated by printing with an ink in which a pigment is dispersed in a thermosetting or photocurable resin, and curing the printed ink with heat or light. The printing method can reduce the material cost more than other methods. However, since it is difficult to precisely adjust the positions of three color filter patterns during the printing, it is rarely used for forming a precise and delicate image and the formed thin film may not be uniform.

The electrophoretic deposition method is a coloring method using an electrophoretic deposition solution including a dye or pigment. One example of an electrophoretic deposition method is an electric precipitation method, such as disclosed in Korean Patent Publication Nos. 1993-7000858 and 1996-0029904. The electrophoretic deposition method can form a delicate color network, and since it can use a pigment, the resultant product can have excellent heat resistance and light resistance. However, as the required size of pixels becomes finer and finer, delicate electrode patterns may cause coloring stains at both ends thereof due to electrical resistance or may result in a thick colored film. Therefore, it can be difficult to fabricate a color filter with a high degree of preciseness using the electrophoretic deposition method.

The inkjet printing method fabricates the light shield film by forming a light shield film on a glass substrate and injecting an ink into a pixel space. An example of the inkjet printing method is disclosed in Korean Patent Publication Nos. 1995-7030746 and 1996-0011513 in which a light shield film is formed on a glass substrate of a color filter and ink is injected into a pixel space. However, inkjet printers typically jet a color resist composition including a dye from a nozzle to achieve delicate and precise color printing. Accordingly, the inkjet printing method also has the problems of low durability and low heat resistance associated with of the dyeing method.

The pigment dispersing method fabricates a color filter by repeating a series of processes including coating a transparent substrate with a photopolymerization composition including a coloring agent, exposing the substrate to light through a pattern of a desired shape, and removing unexposed areas with a solvent to thereby thermoset the resultant structure. The pigment dispersing method can be advantageous because it can maintain a uniform film thickness while improving heat resistance and durability, which are some of the most important characteristics of a color filter. Accordingly, pigment dispersing methods are widely used to fabricate light shield films. Examples of methods for fabricating a color resist using pigment dispersion are set forth in Korean Patent Publication Nos. 1992-7002502, 1994-0005617, 1995-0011163, and 1995-0700359.

The light shield film fabricated using a pigment dispersing method is fabricated by using a photosensitive resin composition. The photosensitive resin composition includes a polymer which functions as a supporter and maintains a uniform thickness, a pigment dispersion solution, a polymerization initiator, an epoxy resin, a solvent, and other additives. The polymer is formed of two elements, which are a binder resin and a photopolymerizable monomer for forming a photoresist pattern by reaction with light during the light exposure. Non-limiting examples of the binder resin used for the pigment dispersion method include a polyimide resin disclosed in Japanese Patent Laid-Open Publication No. Sho 60-237403, and a photosensitive resin including an acryl-based polymer disclosed in Japanese Patent Laid-Open Publication Nos. Hei 1-200353, Hei 4-7373, and Hei 4-91173; a radical polymerization-type photosensitive resin including an acrylate monomer, an organic polymer binder, and a photopolymerization initiator disclosed in Japanese Patent Laid-Open Publication No. Hei 1-152449; and a photosensitive resin including a phenol resin, a cross-linking agent having an N-methylol structure, and a photo acid generator disclosed in Japanese Patent Laid-Open Publication No. Hei 4-163552 and Korean Patent Publication No. 1992-0005780.

Although using a photosensitive polyimide or a phenol-based resin as a binder resin in a pigment dispersion method has an advantage of high heat resistance, there are also drawbacks of low sensitivity and use of an organic solvent for development. Also, a conventional system using an azide compound as a photoresist has problems of low sensitivity, degraded heat resistance, and an oxygen effect during exposure.

To solve these problems, a method of setting up an oxygen blocking film or a method of exposure to an inert gas may be used. Such methods, however, can complicate the process and increase equipment cost. Also, the photosensitive resin which forms an image by using an acid produced from the exposure has advantages of high sensitivity and being unaffected by oxygen during the exposure. However, it can be difficult to manage processing this resin because the photosensitive resin requires a heating process during the exposure and development and the heating time is sensitive with respect to formation of a pattern.

To solve these problems, Japanese Patent Laid-Open Publication Nos. Hei 7-64281, Hei 7-64282, Hei 8-278630, Hei 6-1938, and Hei 5-339356 and Korean Patent Publication No. 1995-7002313 disclose methods of fabricating a color filter by using a cardo-based binder resin.

Generally, an acryl-based resin has excellent heat resistance, shrinkage resistance, and chemical resistance. However, such photosensitive resin compositions tend to have degraded photosensitivity, development characteristics, and adherence. Moreover, the photosensitivity, the development characteristics, and the adherence of a light shield film deteriorate more than in other coloring photosensitive resin compositions because the light shield film needs more black pigment to satisfy the required optical density.

Also, the cardo-based resin has a low taper tilt angle, and it is difficult to increase the tilt angle while securing processability.

### SUMMARY OF THE INVENTION

An embodiment of the present invention provides an organic layer photosensitive resin composition having excellent repellency, photosensitivity, development characteristics, adherence, printability, and taper characteristics, and a low dielectric constant. Another embodiment of the present invention provides an organic layer fabricated using the organic layer photosensitive resin composition, and a color filter including the organic layer.

The embodiments of the present invention are not limited to the above technical purposes, and a person of ordinary skill in the art can understand other technical purposes.

According to one embodiment of the present invention, an organic layer photosensitive resin composition is provided that includes (A) an organic binder resin, (B) a reactive unsaturated compound, (C) a polymerization initiator, (D) a black pigment including a lactam-based black pigment, and (E) a solvent.

According to another embodiment of the present invention, an organic layer fabricated using the organic layer photosensitive resin composition is provided.

According to a further embodiment of the present invention, a color filter including the organic layer is provided.

Further embodiments of the present invention will be described in detail.

The organic layer photosensitive resin composition fabricated according to an embodiment of the present invention has such a low dielectric constant that when it is formed on a thin film transistor (TFT) substrate it does not affect the operation of liquid crystal. With excellent repellency, the organic layer photosensitive resin composition may be used to directly fabricate a color filter on the TFT substrate. The organic layer photosensitive resin composition may also be used for forming barrier ribs partitioning a color filter when the color filter is fabricated using an inkjet method.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, unless a specific definition is otherwise provided, the term “substituted” refers to one substituted with a substituent selected from hydroxy, halogen, substituted or unsubstituted linear or branched alkyl, cycloalkyl, heterocycloalkyl, alkoxy, aryl, heteroaryl, alkenyl, and a combination thereof, instead of hydrogen.

As used herein, unless a specific definition is otherwise provided, the term “alkyl” refers to C1 to C30 linear or branched alkyl, the term “cycloalkyl” refers to C3 to C20 cycloalkyl, the term “heterocycloalkyl” refers to C2 to C20 heterocycloalkyl, the term “alkoxy” refers to C1 to C20 alkoxy, the term “aryl” refers to C6 to C40 aryl, the term “heteroaryl” refers to a C2 to C30 heteroaryl, and the term “alkenyl” refers to C2 to C20 alkenyl.

As used herein, unless a specific definition is otherwise provided, the terms “heterocycloalkyl” and “heteroaryl” refer to one including 1 to 20 heteroatoms, for example 1 to 15 heteroatoms, and as another example 1 to 5 heteroatoms, and the heteroatoms are selected from N, O, S, Si, and combinations thereof.

The organic layer photosensitive resin composition according to one embodiment of the present invention includes (A) an organic binder resin, (B) a reactive unsaturated compound, (C) a polymerization initiator, (D) a black pigment including a lactam-based black pigment, and (E) a solvent.

Hereinafter, the components of the organic layer photosensitive resin composition according to one embodiment of the present invention are illustrated in detail.

(A) Organic Binder Resin

The organic binder resin may include a cardo-based resin, an acryl-based resin, or a combination thereof.

The cardo-based resin may be represented by the following Chemical Formula 1.

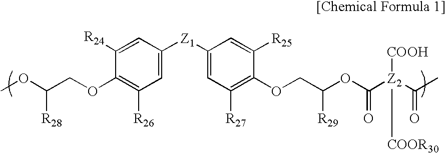

In the above Chemical Formula 1,

each R₂₄ to R₂₇ is the same or different, and is independently hydrogen, halogen, or substituted or unsubstituted alkyl,

each R₂₉ and R₂₉ is the same or different, and is independently hydrogen or CH₂ORₐ wherein Rₐ is vinyl, acryl, or methacryl,

R₃₀ is hydrogen, alkyl, acryl, vinyl, or methacryl,

Z₁ is CO, SO₂, CR_{b}R_{c}, SiR_{d}Rₑ, wherein each R_{b} to Rₑ is the same or different and is independently hydrogen, fluoroalkyl, or alkyl, 0, a single bond, or a substituent represented by the following Chemical Formulae 2 to 12, and

Z₂ is a moiety derived from acid anhydride or acid dianhydride.

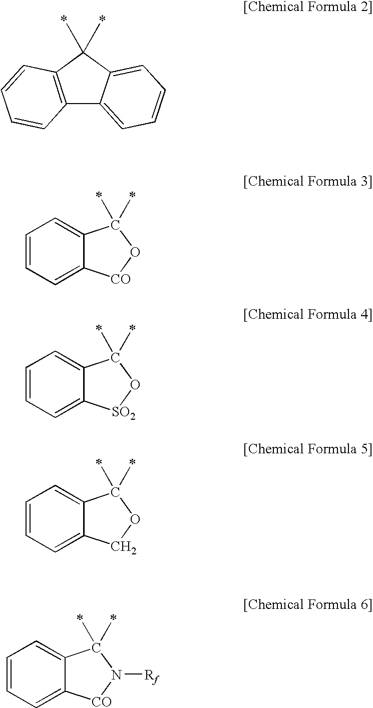

wherein in the above Chemical Formula 6,

R_{f} is hydrogen, ethyl, C₂H₄Cl, C₂H₄OH, CH₂CH═CH₂, or phenyl.

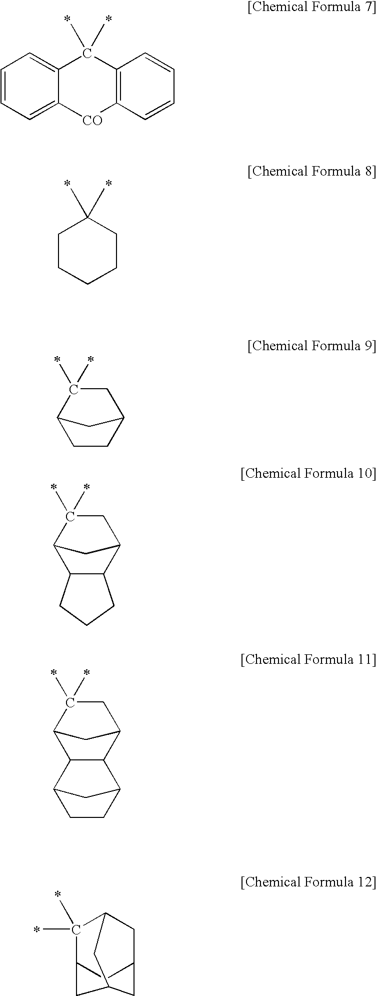

Non-limiting examples of the cardo-based resin include 3,3-bis-(4-hydroxyphenyl)-2-benzofuran-1(3H)-one, 3,3-bis-(4-hydroxy-3-methylphenyl)-2-benzofuran-1(3H)-one, 3,3-bis-(4-hydroxy-2,5-dimethylphenyl)-2-benzofuran-1(3H)-one, 3,3-bis-(4-hydroxy-1-naphthyl)-2-benzofuran-1(3H)-one, 3,3-bis-(4-hydroxy-5-isopropyl-2-methylphenyl)-2-benzofuran-1(3H)-one, 3,3-bis-(3,5-dibromo-4-hydroxyphenyl)-2-benzofuran-1(3H)-one, 3,3-bis-(4-hydroxy-3,5-diiodinephenyl)-2-benzofuran-1(3H)-one, 9,9-bis-(4-hydroxyphenyl)-10-anthrone, 1,2-bis-(4-carboxylphenyl)carborane, 1,7-bis-(4-carboxylphenyl)carborane, 2-bis-(4-carboxylphenyl)-N-phenyl phthalimidine, 3,3-bis-(4′-carboxylphenyl) phthalide, 9,10-bis-(4-aminophenyl)-anthracene, anthrone dianiline, aniline phthalein, and the like, and combinations thereof.

The cardo-based resin may be obtained from bis-(4-hydroxyphenyl)sulfone, bis-(4-hydroxy-3,5-dimethylphenyl)sulfone, bis-(4-hydroxy-3,5-dichlorophenyl)sulfone, bis-(4-hydroxyphenyl)hexafluoropropane, bis-(4-hydroxy-3,5-dimethylphenyl)hexafluoropropane, bis-(4-hydroxy-3,5-dichlorophenyl)hexafluoropropane, bis-(4-hydroxyphenyl)dimethylsilane, bis-(4-hydroxy-3,5-dimethylphenyl)dimethylsilane, bis-(4-hydroxy-3,5-dichlorophenyl)dimethylsilane, bis-(4-hydroxyphenyl)methane, bis-(4-hydroxy-3,5-dichlorophenyl)methane, bis-(4-hydroxy-3,5-dibromophenyl)methane, 2,2-bis-(4-hydroxyphenyl)propane, 2,2-bis-(4-hydroxy-3,5-dimethylphenyl)propane, 2,2-bis-(4-hydroxy-3,5-dichlorophenyl)propane, 2,2-bis-(4-hydroxy-3-methylphenyl)propane, 2,2-bis-(4-hydroxy-3-chlorophenyl)propane, bis-(4-hydroxyphenyl)ether, bis-(4-hydroxy-3,5-dimethylphenyl)ether, bis-(4-hydroxy-3,5-dichlorophenyl)ether, 9,9-bis-(4-hydroxyphenyl)fluorene, 9,9-bis-(4-hydroxy-3-methylphenyl)fluorene, 9,9-bis-(4-hydroxy-3-chlorophenyl)fluorene, 9,9-bis-(4-hydroxy-3-bromophenyl)fluorene, 9,9-bis-(4-hydroxy-3-fluorophenyl)fluorene, 9,9-bis-(4-hydroxy-3-methoxyphenyl)fluorene, 9,9-bis-(4-hydroxy-3,5-dimethylphenyl)fluorene, 9,9-bis-(4-hydroxy-3,5-dichlorophenyl)fluorene, 9,9-bis-(4-hydroxy-3,5-dibromophenyl)fluorene, and the like, and combinations thereof.

In the above Chemical Formula 1, Z₂ is a moiety derived from acid anhydride or acid dianhydride. Non-limiting examples of the acid anhydride compound include anhydrous methylenedomethylenetetrahydrophthalic acid, anhydrous chlorendic acid, anhydrous methyl tetrahydrophthalic acid, and the like, and combinations thereof, and non-limiting examples of the acid dianhydride compound include an aromatic polycarboxylic acid anhydride such as anhydrous pyromellitic acid, benzophenone tetracarboxylic acid dianhydride, biphenyl tetracarboxylic acid dianhydride, biphenyl ether tetracarboxylic acid dianhydride, and the like, and combinations thereof.

The cardo-based resin represented by the above Chemical Formula 1 can have excellent compatibility and can improve the close adhesive property and film strength. Also, the cardo-based resin can have excellent heat resistance and light resistance which can allow processing at a high temperature.

The photosensitive resin composition can include the cardo-based resin in an amount ranging from about 1 to about 40 wt %, for example, about 2 to about 10 wt %, based on the total weight of the photosensitive resin composition. When the amount of the cardo-based resin is within this range, the pattern can closely adhere to a substrate and can provide high sensitivity.

The cardo-based resin may have a weight average molecular weight (Mw) ranging from about 3,000 to about 20,000, for example, from about 5,000 to about 10,000. When the molecular weight of the cardo-based resin is less than about 3,000, patternability may deteriorate. When the molecular weight of the cardo-based resin exceeds about 20,000, residue may remain after development.

The acryl-based resin is an acryl-based resin obtained by radical-polymerization of 3 to 5 kinds of (meth)acryl-based monomers.

The acryl-based resin may be a copolymer including a repeating unit represented by the following Chemical Formulae 13a to 13d.

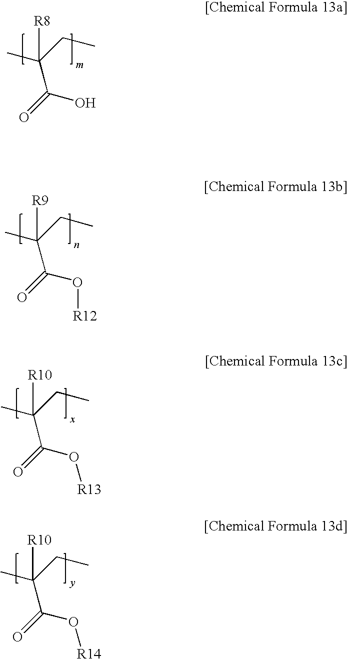

In the above Chemical Formulae 13a to 13d,

each R₈ to R₁₁ is the same or different and is independently hydrogen, methyl, or hydroxymethyl,

R₁₂ is substituted or unsubstituted C1 to C10 alkyl or substituted or unsubstituted C6 to C20 aryl,

R₁₃ is C1 to C10 alkyl including hydroxy,

R₁₄ is substituted or unsubstituted C2 to C15 alkyl, substituted or unsubstituted C3 to C20 cycloalkyl, or substituted or unsubstituted C6 to C20 aryl,

m ranges from 0.1 to 0.5,

n ranges from 0.01 to 0.9,

x ranges from 0.01 to 0.9, and

y ranges from 0.01 to 0.9.

The photosensitive acryl-based resin including a repeating unit represented by the above Chemical Formulae 13a to 13d is not limited to a particular copolymer shape, that is, it may be a block copolymer where the repeating unit is repeated regularly, or it may be a random copolymer where the repeating unit is randomly repeated.

The acryl-based resin may have a weight average molecular weight of about 5,000 to about 40,000. When the weight average molecular weight of the acryl-based resin is within this range, development can become easy and pattern linearity can be excellent.

The photosensitive resin composition can include the acryl-based resin in an amount of about 1 to about 40 wt % based on the total weight of the photosensitive resin composition. When the content of the acryl-based resin is within this range, it is possible to form a barrier rib pattern with a high taper property while preventing undercut.

Also, when a mixture of the cardo-based resin and the acryl-based resin is used, the total amount of the cardo-based resin and the acryl-based resin may range from about 1 to about 40 wt % based on the total weight of the photosensitive resin composition, and the mixing ratio may be freely adjusted in a range of about 100:0 to about 0:100.

(B) Reactive Unsaturated Compound

The reactive unsaturated compound may be a generally-used monomer or oligomer for a thermally curable or photocurable resin composition. Non-limiting examples include ethylene glycol diacrylate, triethylene glycol diacrylate, 1,4-butanediol diacrylate, 1,6-hexanediol diacrylate, neopentylglycol diacrylate, pentaerythritol diacrylate, pentaerythritol triacrylate, dipentaerythritol diacrylate, dipentaerythritol triacrylate, dipentaerythritol pentaacrylate, pentaerythritol hexaacrylate, bisphenol A diacrylate, novolacepoxyacrylate, ethylene glycol dimethacrylate, diethylene glycol dimethacrylate, triethylene glycol dimethacrylate, propylene glycol dimethacrylate, 1,4-butanediol dimethacrylate, 1,6-hexanediol dimethacrylate, and combinations thereof.

The photosensitive resin composition may include the reactive unsaturated compound in an amount ranging from about 1 to about 40 wt % based on the total weight of the photosensitive resin composition. Within this amount range of the reactive unsaturated compound, proper reliability may be acquired because the pattern is sufficiently cured after formation, and excellent resolution and adherence can be acquired. Moreover, the reactive unsaturated compound may be used after being treated with acid anhydride to be easily dissolved in an alkali aqueous solution.

(C) Polymerization Initiator

The initiator may be a photopolymerization initiator, a radical initiator, or a combination thereof.

The photopolymerization initiator may include at least one of an acetophenone-based compound, a benzophenone-based compound, a thioxanthone-based compound, a benzoin-based compound, a triazine-based compound, a carbazole-based compound, a diketone compound, a sulfonium borate-based compound, a diazo-based compound, an imidazole-based compound, or a biimidazole-based compound.

Non-limiting examples of the acetophenone-based compound include 2,2′-diethoxyacetophenone, 2,2′-dibutoxyacetophenone, 2-hydroxy-2-methylpropinophenone, p-t-butyltrichloroacetophenone, p-t-butyldichloroacetophenone, 4-chloroacetophenone, 2,2′-dichloro-4-phenoxyacetophenone, 2-methyl-1-(4-(methylthio)phenyl)-2-morpholinopropan-1-one, 2-benzyl-2-dimethylamino-1-(4-morpholinophenyl)-butan-1-one (commercially available as Igacure™ 396, Ciba-Geigy Company), and the like, and combinations thereof.

Non-limiting examples of the benzophenone-based compound include benzophenone, 4,4′-dimethylaminobenzophenone, 4,4′-dichlorobenzophenone, 3,3′-dimethyl-2-methoxybenzophenone, 4,4′-dimethylbenzophenone, benzoyl benzoic acid, benzoyl methyl benzoate, 4-phenyl benzophenone, hydroxy benzophenone, acrylated benzophenone, 4,4′-bis-(dimethyl amino)benzophenone, 4,4′-bis(diethyl amino) benzophenone, and the like, and combinations thereof.

Non-limiting examples of the thioxanthone-based compound include thioxanthone, 2-methylthioxanthone, isopropyl thioxanthone, 2,4-diethyl thioxanthone, 2,4-diisopropyl thioxanthone, 2-chloro thioxanthone, and the like, and combinations thereof.

Non-limiting examples of the benzoin-based compound include benzoin, benzoin methyl ether, benzoin ethyl ether, benzoin isopropyl ether, benzoin isobutyl ether, benzyldimethylketal, and the like, and combinations thereof.

Non-limiting examples of the triazine-based compound include 2,4,6-trichloro s-triazine, 2-(4′-methylphenyl)-4,6-bis-(trichloromethyl)-s-triazine, 2-(4′-ethylphenyl)-4,6-bis-(trichloro methyl)-s-triazine, 2-(4′-n-butylphenyl)-4,6-bis-(trichloro methyl)-s-triazine, 2-phenyl 4,6-bis-(trichloro methyl)-s-triazine, 2-(3′,4′-dimethoxy styryl)-4,6-bis-(trichloro methyl)-s-triazine, 2-(4′-methoxy naphthyl)-4,6-bis-(trichloro methyl)-s-triazine, 2-(p-methoxy phenyl)-4,6-bis-(trichloro methyl)-s-triazine, 2-(p-tolyl)-4,6-bis-(trichloromethyl)-s-triazine, 2-biphenyl 4,6-bis-(trichloromethyl)-s-triazine, bis-(trichloromethyl)-6-styryl s-triazine, 2-(naphto-1-yl)-4,6-bis-(trichloro methyl)-s-triazine, 2-(4-methoxy naphto-1-yl)-4,6-bis-(trichloro methyl)-s-triazine, 2,4-trichloro methyl(piperonyl)-6-triazine, 2,4-trichloro methyl (4′-methoxy styryl)-6-triazine, and the like, and combinations thereof.

The radical polymerization initiator may include a peroxide-based initiator or an azo-bis-based initiator.

Non-limiting examples of the peroxide-based initiator may include ketoneperoxides such as methylethyl ketoneperoxide, methylisobutyl ketoneperoxide, cyclohexanone peroxide, methylcyclohexanone peroxide, acetylacetone peroxide, and the like; diacylperoxides such as isobutyrylperoxide, 2,4-dichlorobenzoylperoxide, o-methylbenzoylperoxide, bis-3,5,5-trimethylhexanoylperoxide, and the like; hydroperoxides such as 2,4,4-trimethylpentyl-2-hydroperoxide, diisopropylbenzenehydroperoxide, cumenehydroperoxide, t-butylhydroperoxide, and the like; dialkylperoxides such as dicumylperoxide, 2,5-dimethyl-2,5-di(t-butylperoxy)hexane, 1,3-bis-(t-butyloxyisopropyl)benzene, t-butylperoxyvaleric acid n-butyl ester, and the like; alkylperesters such as 2,4,4-trimethylpentylperoxyphenoxyacetate, α-cumylperoxyneodecanoate, t-butylperoxybenzoate, di-t-butylperoxytrimethyladipate, and the like; percarbonates such as di-3-methoxybutylperoxydicarbonate, di-2-ethylhexylperoxydicarbonate, bis-4-t-butylcyclohexylperoxydicarbonate, diisopropylperoxydicarbonate, acetylcyclohexylsulfonylperoxide, t-butylperoxyan arylcarbonate, and the like, and combinations thereof.

Non-limiting examples of the azo-bis-based initiator include 1,1′-azo-bis-cyclohexane-1-carbonitrile, 2,2′-azo-bis-(2,4-dimethylvaleronitrile), 2,2,-azo-bis-(methylisobutyrate), 2,2′-azo-bis-(4-methoxy-2,4-dimethylvaleronitrile), α,α′-azo-bis-(isobutylnitrile), 4,4′-azo-bis-(4-cyano valeric acid), and the like, and combinations thereof.

The polymerization initiator may be used singularly or in combination of two or more. Also, a sensitizer such as tetraethylene glycol bis-3-mercapto propionate, pentaerythritol tetrakis-3-mercapto propionate, or dipentaerythritol tetrakis-3-mercapto propionate may be used together with the polymerization initiator.

The photosensitive resin composition may include the polymerization initiator in an amount ranging from about 0.1 to about 10 wt % based on the total weight of the photosensitive resin composition. When the amount of the polymerization initiator is within this range, the time for curing after the formation of a pattern may be sufficient. Thus, reliability may be secured and excellent resolution and a close contacting property may be acquired.

(D) Black Pigment Including Lactam-based Black Pigment

A black pigment may be used to block the light in the light shield film. In an embodiment of the present invention, a lactam-based black pigment is used.

Lactam-based black pigments are known and are commercially available, and any of the types of lactam-black pigments may be suitable for use in the present invention. Non-limiting examples of lactam-based black pigment useful in the present invention can include black 582 (Ciba Company) and black 002 (Sakata Ink Company), and combinations thereof.

The lactam-based black pigment has a low dielectric constant, and it replaces carbon black in a photosensitive resin composition to thereby block light and provide a light shield film having a low dielectric constant during the fabrication of the light shield film.

The photosensitive resin composition may include the lactam-based black pigment in an amount ranging from about 5 to about 20 wt % based on the total weight of the photosensitive resin composition. When the lactam-based black pigment is used within this range, light can be effectively blocked.

Also, the lactam-based black pigment and other black pigments may be mixed and used as the black pigment. Non-limiting examples of black pigments that can be mixed and used include perylene black, aniline black, titan black, carbon black, and the like, and combinations thereof. Also, a color calibrator may be used along with the black pigment. Non-limiting examples of color calibrators include a condensed polycyclic pigment such as an anthraquinone-based pigment and a perylene-based pigment, or an organic pigment such as a phthalocyanine pigment and an azo pigment.

When a mixture of the lactam-based black pigment and another black pigment is used, the black pigment may be added in an amount that does not affect the physical properties of the lactam-based black pigment. As an example, the black pigment may be added in an amount ranging from about 1 to about 40 parts by weight based on about 100 parts by weight of the lactam-based black pigment.

Also, a dispersing agent may be used to disperse the pigment in the photosensitive resin composition according to an embodiment of the present invention. For example, the pigment may be surface-treated with a dispersing agent in advance or a dispersing agent may be added during the preparation of the photosensitive resin composition, other than the pigment.

Non-limiting examples of the dispersing agent may include a non-ionic, anionic, or cationic dispersing agent. For example, the dispersing agent may include polyalkylene glycol or an ester thereof, polyoxyalkylene, a polyhydric alcohol ester alkylene oxide additive, an alcohol alkyleneoxide additive, a sulfonic acid ester, a sulfonate, a carboxylic acid ester, a carboxylate, an alkylamide alkylene oxide additive, an alkylamine, and the like. These dispersing agents may be used singularly or in combination of two or more. The dispersing agent may be included in an amount of about 0 to about 10 parts by weight based on about 100 parts by weight of a pigment, but the amount is not limited thereto.

(E) Solvent

Non-limiting solvents may include ethylene glycol acetate, ethyl cellosolve, propylene glycol methylether acetate, ethyl lactate, polyethylene glycol, cyclohexanone, propylene glycol methylether, propylene glycol monomethylether, dipropylene glycol ethylmethyl ether, and the like. These solvents may be used singularly or in combination.

The amount of the solvent used may be a balance amount. Although the amount of the solvent is not specifically defined according to the photosensitive resin composition, the solvent may be added at a ratio that allows the resin composition to have a sufficient viscosity to be applied to a substrate.

(F) Other Additives

In addition to components (A) to (E), the photosensitive resin composition may further include additives as a silane coupling agent, a surfactant, an antioxidant, a stabilizer, or a combination thereof, as long as the additives do not damage the physical properties of the photosensitive resin composition.

For example, when added to the photosensitive resin composition, the silane coupling agent can improve adhesiveness between a pattern or a color filter and a substrate. A non-limiting silane coupling agent may be represented by the following Chemical Formula 14.

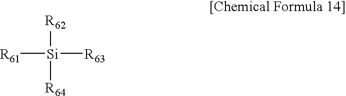

In the above Chemical Formula 14,

R₆₁ is vinyl, substituted or unsubstituted alkyl, or substituted or unsubstituted aryl, for example, is 3-(meth)acryloxypropyl, p-styryl, or 3-(phenylamino)propyl; and

each R₆₂ to R₆₄ is the same or different and is independently substituted or unsubstituted alkoxy, for example C1 to C8 alkoxy, substituted or unsubstituted alkyl, for example C1 to C20 alkyl, or halogen, provided that at least one of R₅₂ to R₆₄ is alkoxy or halogen.

Non-limiting examples of the silane compound include compounds represented by the following Chemical Formulae 15 and 16; a silane compound including an aryl group such as trimethoxy[3-(phenylamino)propyl]silane; a silane compound including a carbon-carbon unsaturated bond such as vinyl trimethoxysilane, vinyl triethoxysilane, vinyl trichlorosilane, vinyl tris(β-methoxyethoxy)silane; 3-methacryloxypropyltrimethoxysilane, 3-acryloxypropyltrimethoxysilane, p-styryl trimethoxysilane, 3-methacryloxypropylmethyldimethoxysilane, 3-methacryloxypropylmethyldiethoxysilane, and the like, and combinations thereof.

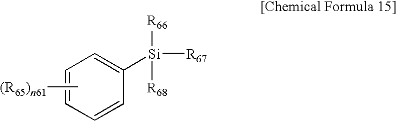

In the above Chemical Formula 15,

R₆₅ is NH₂ or CH₃CONH, each R₆₆ to R₆₈ is the same or different and is independently substituted or unsubstituted alkoxy, for example OCH₃ or OCH₂CH₃, and n₆₁ is an integer ranging from 1 to 5.

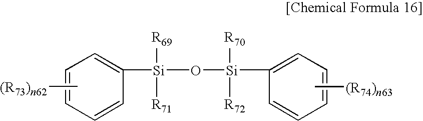

In the above Chemical Formula 16,

each R₆₉ to R₇₂ is the same or different and is independently substituted or unsubstituted alkyl or substituted or unsubstituted alkoxy, for example CH₃ or OCH₃,

each R₇₃ and R₇₄ is the same or different and is independently substituted or unsubstituted amino, for example NH₂ or CH₃CONH, and

each n₆₂ and n₆₃ is the same or different and is independently integers ranging from 1 to 5.

The silane coupling agent may be added in a minute amount, for example, in an amount of about 0.01 to about 5 parts by weight based on about 100 parts by weight of the photosensitive resin composition. Within this range, the photosensitive resin composition may have improved adherence.

Further, if necessary, an epoxy compound may be added to improve the close contacting property and other characteristics. Non-limiting epoxy compounds may include one selected from phenol novolac epoxy resin, tetramethyl biphenyl epoxy resin, bisphenol A-type epoxy resin, alicyclic epoxy resin, and the like, and combinations thereof. The photosensitive resin composition may include the epoxy compound in an amount ranging from about 0.01 to about 5 parts by weight based on about 100 parts by weight of the photosensitive resin composition. When the amount of the epoxy compound is within the range of about 0.01 to about 5 parts by weight, it is possible to economically improve the storage property, the close contacting property, and other characteristics.

Since the organic layer photosensitive resin composition has high repellency, it may be usefully used to form barrier ribs when a color filter of a display device is fabricated through an inkjet method. Also, since it has a low dielectric constant, it may also be used in the fabrication of a color filter directly formed on a TFT substrate. The display device includes an organic layer formed of the organic layer photosensitive resin composition, and a color filter positioned in a region partitioned by the organic layer. The organic layer functions as a light shield film. A non-limiting example of the display device is a liquid crystal display device.

Hereinafter, the present invention is illustrated in more detail with reference to examples. However, they are exemplary embodiments of the present invention and are not limiting.

### Preparation Example 1

2.5 wt % of polyalkylene glycol and 18 wt % of lactam black (Black 582 produced by Ciba Company) are dispersed in 79.5 wt % of propylene glycol metaethylacrylate solvent to thereby prepare a pigment dispersion solution.

### Example 1

A photopolymerization initiator is dissolved in a solvent and agitated at room temperature for two hours. A reactive unsaturated compound, a cardo-based resin, and an acryl-based resin are added to the photopolymerization initiator solution and agitated at room temperature for two hours. Subsequently, the pigment dispersion solution of Preparation Example 1, a silane coupling agent, and a surfactant are added to the acquired reactant and agitated at room temperature for one hour. Then, the product is filtered three times to remove impurities from the agitated solution to thereby prepare a photosensitive resin composition, and the composition ratio of the photosensitive resin composition is as shown in the following Table 1.

TABLE 1

| | | Composition |
|---|---|---|
| | | ratio |
| Photosensitive resin composition | | (wt %) |
| (a) cardo-based resin | V259ME (Nippon Steel Chemical | 3.5 |
| | Group) | |
| | (weight average molecular weight | |
| | (Mw) = 6,000) | |
| (b) acryl-based resin | 300PG-47(Showa Highpolymer | 1.3 |
| | Co., Ltd.) | |
| | (weight average molecular weight | |
| | (Mw) = 12,000) | |
| (c) reactive | dipentaerythritol triacrylate | 2 |
| unsaturated | | |
| compound | | |
| (d) pigment | pigment dispersion solution of | 44 |
| | Preparation Example 1 | |
| (e) | OXE 02 (Ciba-Geigy Corporation) | 3 |
| photopolymerization | Irgacure 369 (Ciba-Geigy | 2 |
| initiator | Corporation) | |
| (f) solvent | propylene glycol monomethylether | 27 |
| | dipropylene glycol ethylmethyl | 16.5 |
| | ether | |
| (g) silane coupling | methacryloxy silane | 0.2 |
| agent | (Chisso Corporation) | |
| (h) surfactant | DS 102 (DIC Corporation) | 0.5 |
| Total | | 100 |

### Example 2

An organic layer photosensitive resin composition is prepared according to the same method as Example 1, except that only 4.8 wt % of cardo-based resin is used without using the acryl-based resin.

### Example 3

An organic layer photosensitive resin composition is prepared according to the same method as Example 1, except that 44 wt % of black 002 produced by Sakada Ink Company is used instead of the pigment dispersion solution of Preparation Example 1.

### Comparative Example 1

An organic layer photosensitive resin composition is prepared according to the same method as Example 1, except that a carbon black dispersion solution CI-M-050 produced by Sakada Ink Company is used as a pigment dispersion solution.

<Measurement of Physical Properties>

The contact angle, dielectric constant, optical density, heat resistance, chemical resistance, adherence, and taper characteristics of the photosensitive resin compositions prepared according to Examples 1 and 2 and Comparative Example 1 are measured, and the results are presented in the following Tables 2 and 3.

1. Measurement of Contact Angle

Glass substrates having a thickness of 1 mm are coated with the organic layer photosensitive resin compositions prepared according to Examples 1 to 3 and Comparative Example 1, respectively, to a thickness of 2 to 3 μm, dried in a hot-air drying furnace at 80° C. for 3 minutes, exposed to an ultra-high-pressure mercury lamp emitting a wavelength of 365 nm, and developed at 23° C. under atmospheric pressure for 100 seconds by using a 1 mol % KOH aqueous solution. Subsequently, a film is formed by drying the resultant structure in the hot-air drying furnace at 230° C. for 30 minutes. The contact angle of the film is measured by dropping 2-ethoxyethanol thereon and using a contact angle measurer.

2. Measurement of Dielectric Constant

ITO substrates having a thickness of 1 mm are coated with the organic layer photosensitive resin compositions prepared according to Examples 1 to 3 and Comparative Example 1, respectively, to a thickness of 2 to 3 μm, dried in a hot-air drying furnace at 80° C. for 3 minutes, and exposed to an ultra-high-pressure mercury lamp emitting a wavelength of 365 nm. Subsequently, the resultant structure is dried in the hot-air drying furnace at 230° C. for 30 minutes and part of a formed film is scraped to expose the ITO substrate. An aluminum electrode is deposited on the exposed ITO substrate to thereby produce a sample. The capacitance of the sample is measured by using a precision impedance analyzer (Model No. 4294A produced by HP Company), and the measured capacitance is inputted to the following Equation 1 to calculate a dielectric constant.

$${ɛ}_{r} = \frac{C}{{ɛ}_{0}} \times \frac{t}{A} \qquad [ Equation 1 ]$$

∈ᵣ: relative dielectric constant

∈₀: dielectric constant under vacuum, ∈₀=8.854×10⁻¹⁴[F/cm]

t: thickness (cm), 1 μm=1×10⁻⁴ cm, and

A: area (cm²⁾

Data permissible error: ±5% (upper electrode deposit area measurement error)

3. Evaluation of Optical Density

Glass substrates having a thickness of 1 mm are coated with the organic layer photosensitive resin compositions prepared according to Examples 1 to 3 and Comparative Example 1, respectively, to a thickness of 2.5 μm, and dried in a hot-air drying furnace at 80° C. for 3 minutes to thereby form a film on each glass substrate. The glass substrates with the film formed thereon are cooled to room temperature, and then dried in the hot-air drying furnace at 230° C. for 30 minutes. The optical densities of the films formed on the respective substrates are measured with a 310TR optical density meter (produced by X-Rite Company).

Evaluation Reference

∘: Optical density is 3.5 or higher

Δ: Optical density is between 2.5 and 3.5

x: Optical density is 2.5 or lower

4. Evaluation of Heat Resistance

Glass substrates having a thickness of 1 mm are coated with the organic layer photosensitive resin compositions prepared according to Examples 1 to 3 and Comparative Example 1, respectively, to a thickness of 2 to 3 μm, dried in a hot-air drying furnace at 80° C. for 3 minutes, and exposed to an ultra-high-pressure mercury lamp emitting a wavelength of 365 nm. Subsequently, a film is formed on each substrate by drying the substrates coated with the organic layer photosensitive resin compositions in the hot-air drying furnace at 230° C. for 30 minutes. The films are heated in the hot-air drying furnace at 250° C. for 1 minute, and the heat resistances of the films are assessed by measuring the optical density difference (ΔOD) between the fabricated samples and the original sample.

Evaluation Reference

∘: Optical density difference (ΔOD) is 0.5 or lower

Δ: Optical density difference (ΔOD) is between 0.5 and 1

x: Optical density difference (ΔOD) is 1 or higher

5. Evaluation of Chemical Resistance

Glass substrates having a thickness of 1 mm are coated with the organic layer photosensitive resin compositions prepared according to Examples 1 to 3 and Comparative Example 1, respectively, to a thickness of 2 to 3 μm, and dried in a hot-air drying furnace at 80° C. for 3 minutes to thereby form a film on each substrate. The films are irradiated by an ultra-high-pressure mercury lamp having a wavelength of 365 nm, developed using a 1 mol % KOH aqueous solution at 23° C. under atmospheric pressure for 100 seconds, and then dried in the hot-air drying furnace at 230° C. for 30 minutes to thereby acquire patterns. The patterns are immersed in a mixed solution of 5 mol % HCl, 5 mol % NaOH aqueous solution, xylene, N-methylpyrrolidone, isopropylalcohol, and acetone. Then, the chemical resistances of the patterns are evaluated by measuring an optical density difference between the samples and the original sample.

Evaluation Reference

∘: Optical density difference (ΔOD) is 0.5 or lower

Δ: Optical density difference (ΔOD) is between 0.5 and 1

x: Optical density difference (ΔOD) is 1 or higher

6. Evaluation of Adherence

Glass substrates having a thickness of 1 mm are coated with the organic layer photosensitive resin compositions prepared according to Examples 1 to 3 and Comparative Example 1, respectively, to a thickness of 2 to 3 μm, and dried in a hot-air drying furnace at 80° C. for 3 minutes to thereby form a film on each substrate. The films are irradiated by an ultra-high-pressure mercury lamp having a wavelength of 365 nm with a light exposure amount of 100 mJ/cm², dried in a hot-air drying furnace at 230° C. for 30 minutes, and patterned to have 100 square cells, the size of each being 1 mm×1 mm. Then, a delamination experiment using contact tape is performed on the films and the delamination state is evaluated with the bare eye.

Evaluation Reference

∘: 100/100 (the number of peeled-off blocks/the number of blocks)-no delamination

Δ: 80/100 to 99/100

x: 0/100 to 79/100

7. Measurement of Development Characteristic

Cleaned and degreased glass substrates having a thickness of 1 mm are coated with the organic layer photosensitive resin compositions prepared according to Examples 1 to 3 and Comparative Example 1, respectively, to a thickness of 2 to 3 μm, and dried over a hot plate at a uniform temperature of 80° C. for 3 minutes to thereby form a film on each substrate. The films are exposed to an ultra-high-pressure mercury lamp having a wavelength of 365 nm through a photomask disposed over the films, and developed at 23° C. under atmospheric pressure for 100 seconds by using a 1 mol % KOH-based aqueous solution. After the development, the films are dried in a hot-air drying furnace at a uniform temperature of 230° C. for 30 minutes to thereby acquire patterns. The patternabilities of the patterns are evaluated using an optical microscope.

8. Evaluation of Taper

Cross-section images of the patterns formed for evaluating the following development margins are acquired using a scanning electron microscope (SEM), and a tilt angle between each pattern and the horizontal surface of the substrate is measured.

9. Evaluation of Development Margins

Cleaned and degreased glass substrates having a thickness of 1 mm are coated with the organic layer photosensitive resin compositions prepared according to Examples 1 to 3 and Comparative Example 1, respectively, to a thickness of 2 to 3 μm, and dried over a hot plate at a uniform temperature of 80° C. for 3 minutes to thereby form a film on each substrate. Subsequently, the formed films are irradiated by an ultra-high-pressure mercury lamp having a wavelength of 365 nm through a photomask including mask sizes of 8, 10, 20, 30, and 50 μm disposed on the films, and developed using a 1 mol % KOH aqueous solution at 23° C. under atmospheric pressure for a predetermined time. The sizes of remaining patterns are observed to evaluate the development margins.

TABLE 2

| | Contact | Dielectric | Optical | Heat | Chemical | | Taper |
|---|---|---|---|---|---|---|---|
| | angle | constant | density | resistance | resistance | Adherence | (tilt angle) |
| Example 1 | 51° | 4.5 | ∘ | ∘ | ∘ | ∘ | 74° |
| Example 2 | 53° | 4.5 | ∘ | ∘ | ∘ | ∘ | 65° |
| Example 3 | 51° | 5 | ∘ | ∘ | ∘ | ∘ | 63° |
| Comparative | 25° | 40 | ∘ | ∘ | ∘ | ∘ | 42° |
| Example 1 | | | | | | | |

TABLE 3

| | Remaining minimum pattern size (μm) | | |
|---|---|---|---|
| | 80 seconds | 90 seconds | 100 seconds |
| Example 1 | 5 | 10 | 10 |
| Example 2 | 5 | 8 | 10 |
| Example 3 | 5 | 10 | 10 |
| Comparative | 5 | 10 | 10 |
| Example 1 | | | |

Referring to Table 2, the photosensitive resin compositions of Examples 1 to 3 show equivalent optical density, heat resistance, chemical resistance, and adherence compared to the photosensitive resin composition of Comparative Example 1.

The taper characteristic of the photosensitive resin compositions of Examples 1 to 3 is superior to that of the photosensitive resin composition of Comparative Example 1.

Also, the photosensitive resin compositions of Examples 1 to 3 have remarkably low dielectric constants, compared with the photosensitive resin composition of Comparative Example 1.

Since the photosensitive resin compositions of Examples 1 to 3 have a greater contact angle than the photosensitive resin composition of Comparative Example 1, the photosensitive resin compositions of Examples 1 to 3 have excellent repellency.

Table 3 also shows that the photosensitive resin compositions of Examples 1 to 3 have more development margins than the photosensitive resin composition of Comparative Example 1.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. An organic layer photosensitive resin composition, comprising
(A) an organic binder resin;
(B) a reactive unsaturated compound;
(C) a polymerization initiator;
(D) a black pigment including a lactam-based black pigment; and
(E) a solvent.

2. The composition of claim 1, wherein the organic binder resin comprises a cardo-based resin, an acryl-based resin, or a combination thereof.

3. The composition of claim 2, wherein the cardo-based resin is represented by the following Chemical Formula 1: 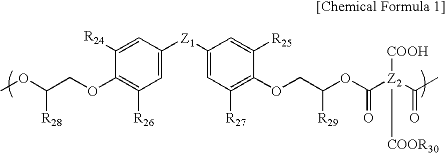
wherein, in the above Chemical Formula 1,
each R₂₄ to R₂₇ is the same or different, and is independently hydrogen, halogen, or substituted or unsubstituted alkyl,
each R₂₈ and R₂₉ is the same or different, and is independently hydrogen or CH₂ORₐ where Rₐ is vinyl, acryl, or methacryl,
R₃₀ is hydrogen, alkyl, acryl, vinyl, or methacryl,
Z₁ is CO, SO₂, CR_{b}R_{c}, SiR_{d}Rₑ, wherein each R_{b} to Rₑ is the same or different, and is independently hydrogen, fluoroalkyl, or alkyl, O, a single bond, or substituents represented by the following Chemical Formulae 2 to 12, and
Z₂ is a moiety derived from acid anhydride or acid dianhydride, 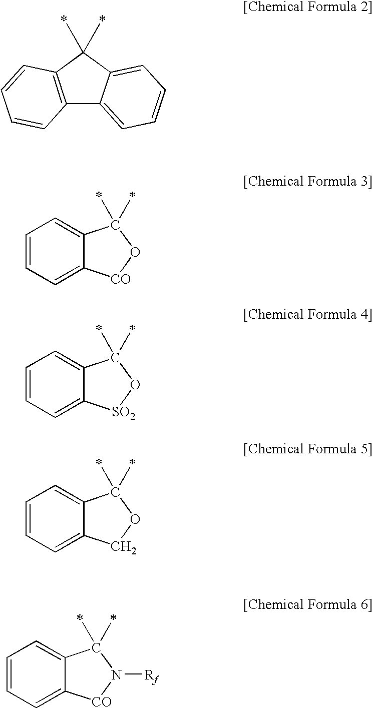
wherein, in the above Chemical Formula 6,
R_{f} is hydrogen, ethyl, C₂H₄Cl, C₂H₄OH, CH₂CH═CH₂, or phenyl,

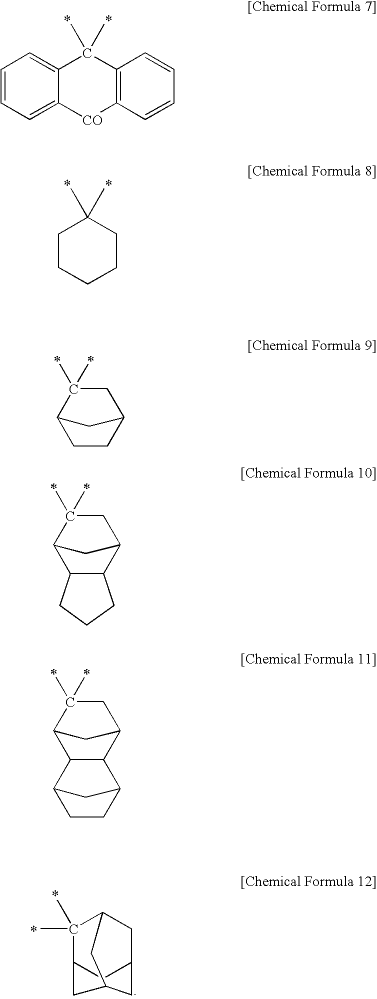

4. The composition of claim 2, wherein the acryl-based resin comprises a repeating unit represented by the following Chemical Formulae 13a to 13d: 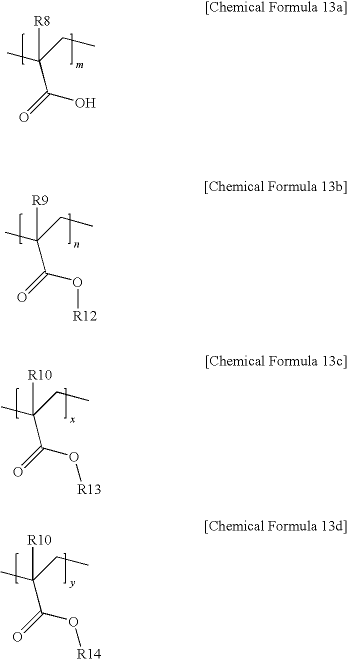
wherein, in the above Chemical Formulae 13a to 13d,
each R₈ to R₁₁ is the same or different and is independently hydrogen, methyl, or hydroxymethyl,
R₁₂ is substituted or unsubstituted C1 to C10 alkyl or substituted or unsubstituted C₆ to C₂₀ aryl,
R₁₃ is C1 to C10 alkyl including hydroxy,
R₁₄ is substituted or unsubstituted C2 to C15 alkyl, substituted or unsubstituted C3 to C20 cycloalkyl, or substituted or unsubstituted C6 to C20 aryl,
m ranges from 0.1 to 0.5,
n ranges from 0.01 to 0.9,
x ranges from 0.01 to 0.9, and
y ranges from 0.01 to 0.9.

5. The composition of claim 1, wherein the organic layer photosensitive resin composition comprises: about 1 to about 40 wt % of the organic binder resin (A); about 1 to about 40 wt % of the reactive unsaturated compound (B); about 0.1 to about 10 wt % of the polymerization initiator (C); about 5 to about 20 wt % of the black pigment including a lactam-based black pigment (D); and (E) the balance of a solvent.

6. The composition of claim 2, wherein the cardo-based resin has a weight average molecular weight (Mw) of about 5,000 to about 40,000.

7. The composition of claim 2, wherein the acryl-based resin has a weight average molecular weight (Mw) of about 5,000 to about 40,000.

8. The composition of claim 1, wherein the polymerization initiator comprises a photopolymerization initiator, a radical initiator, or a combination thereof.

9. The composition of claim 1, wherein the organic layer photosensitive resin composition further comprises a silane coupling agent in an amount of about 0.01 to about 5 parts by weight based on about 100 parts by weight of the organic layer photosensitive resin composition.

10. The composition of claim 1, wherein the organic layer photosensitive resin composition further comprises an epoxy compound in an amount of about 0.01 to about 5 parts by weight based about 100 parts by weight of the organic layer photosensitive resin composition.

11. A color filter organic layer fabricated using the organic layer photosensitive resin composition of claim 1.

12. A color filter comprising an organic layer according to claim 11.
